(19) United States
(12) Patent Application Publication
(10) Pub. No.: US 2017/0074276 A1
(43) Pub. Date: Mar. 16, 2017

(54) METHOD FOR IDENTIFYING THE SURGE LIMIT OF A COMPRESSOR

(71) Applicant: BorgWarner Inc., Auburn Hills, MI (US)

(72) Inventors: Frank DAHINTEN, Neunkirchen a. Br. (DE); Michael MANDEL, Viernheim (DE); Harald STEPPAT, Oberwesel (DE)

(21) Appl. No.: 15/122,657

(22) PCT Filed: Mar. 2, 2015
(86) PCT No.: PCT/US2015/018244

§ 371 Date: Aug. 31, 2016

(30) Foreign Application Priority Data
Mar. 11, 2014 (DE) 102014204418.9

(51) Int. Cl. F04D 27/02; F02B 37/00; F04D 27/00; F02B 33/40; F04D 17/10; F04D 25/06

(52) U.S. Cl. CPC F04D 27/0261; F04D 17/10; F04D 25/06; F04D 27/001; F02B 33/40; F02B 37/00

(57) ABSTRACT

A method for identifying a surge limit of a compressor. The compressor is driven at least by an electric motor, the power of which is regulated by means of a regulation device. The regulation device detects regulation activity during the operation of the compressor. A surge limit of the compressor is identified if the regulation activity or a change in the regulation activity overshoots a threshold value which is assigned to the surge limit.

This invention relates to a method for identifying a surge limit of a compressor which is driven by an electric motor, to a method for operating a compressor of said type so as to prevent a surge limit from being reached, and to a regulation device for a compressor.

Electrically driven compressors can be used as air supply means for fuel cells, as electrically driven auxiliary compressors for combustion engines, and as part of a turbocharger in which an electric motor can drive and/or assist at least the compressor part of the rotor set. An electric motor of said type on a turbocharger can also operate as a generator, and for this purpose, is connected to the exhaust-gas turbine of the exhaust-gas turbocharger.

In the prior art, EP 1 342 895 A2 has disclosed an electrically driven compressor which is equipped with a control/regulation device which can detect wear, deficient lubrication or other damage. Such diagnosis is performed on the basis of a mathematical compressor model. If, in the model, implausible values are detected for the electrical power being drawn by the electric motor and for the calculated power being generated by the electric motor, it is assumed that a fault state is present. The diagnosis may also be performed on the basis of the rotational acceleration or the rotational speed of the compressor, wherein discrepancies in the model are likewise taken into consideration. This technique can be used in particular for faults that arise slowly, such as wear or slow deterioration of the state of the oil or the like. By contrast to this, however, suddenly occurring problems can also damage a compressor. This is the case in particular when a compressor operates at its surge limit.

By contrast to this, it is an object of the present invention to provide a method and a regulation unit which permit reliable operation of the compressor.

This object is achieved by the features of the independent claims. The subclaims relate to advantageous refinements of the invention, wherein the subclaims may be combined with one another in a technologically expedient manner.

Accordingly, the invention provides a method for identifying a surge limit of a compressor, wherein the compressor is driven at least by an electric motor, the power of which is regulated by means of a regulation device, wherein the regulation device detects regulation activity during the operation of the compressor, and wherein a surge limit of the compressor is identified if the regulation activity or a change in the regulation activity overshoots a threshold value.

According to the invention, use is made of the fact that the regulator exhibits increased regulation activity when the operating state of the compressor moves into the vicinity of the surge limit or arrives at the surge limit. This can be utilized to determine the surge limit and/or regulate the compressor such that it does not sustain damage.

The regulator may for example be implemented as a PI regulator or a PID regulator. In the case of the regulation of the power, the PI or PID regulation may relate to the attainment of a particular volume flow rate, of a particular pressure or of a particular rotational speed of the compressor. The power, an output torque or the rotational speed of the electric motor which drives the compressor may be set as the control variable of the regulation.

When the threshold value is reached, it is possible, in reaction to an overshooting of the threshold value, for the operating state of the compressor or operating point of the compressor to be moved away from the surge limit, in the simplest case by a simple reduction of the power, or else by way of a change in the area of the compressor.

In one refinement, the threshold value is determined continuously in an adaptive manner during operation on the basis of the result of an identification of a surge limit.

In one refinement, the threshold value is determined with a margin to a surge limit.

The method may be used at all times during the operation of the compressor or only in operating states in which the compressor operates in an operating state close to the surge limit, and the surge limit can be avoided owing to the reaction to an overshooting of the threshold value. In this way, it is possible for the method to be implemented as required.

In one refinement, the regulation activity is determined on the basis of a regulation amplitude and a regulation frequency, in particular by multiplication of the regulation amplitude and the regulation frequency. In this way, with one very simple processing operation, it is possible for regulation activity for a present time period to be determined and compared with the threshold value.

In an alternative or additional refinement, the regulation activity is determined on the basis of a regulation amplitude and a regulation frequency, in particular by determination of an integral of the amplitudes over a defined frequency range. In this way, an area (integral) can be determined as a descriptive value of the regulation activity and compared with a correspondingly descriptive threshold value.

In a further aspect of the invention, a regulation device for a compressor is proposed, by means of which regulation device one of the methods described above, or embodiments thereof, is carried out. In particular, the regulation device comprises a digital processing unit by means of which one of the above-described methods is carried out.

A regulation device of said type may be formed as part of an engine controller of an internal combustion engine or as part of a regulator/controller of a fuel cell. Said regulation device may also be part of a vehicle regulator/controller of an electrically driven fuel cell vehicle. Such integration saves on cabling outlay and permits a compact construction of the system composed of the compressor and the regulator/controller thereof. Alternatively, the regulation device may also be in the form of a mechanically separate and/or functionally autonomous device which is arranged in particular on the compressor or on a turbocharger. In one variant, said regulation device can additionally perform functions relating to the compressor or a turbocharger.

The method for identifying surging or the onset of surging may also be implemented as machine-readable program code additionally in an already existing regulation device for the regulation of an electrically assisted or driven compressor.

Further details, advantages and features of the present invention become apparent from the following description of an exemplary embodiment with reference to the drawings, in which:

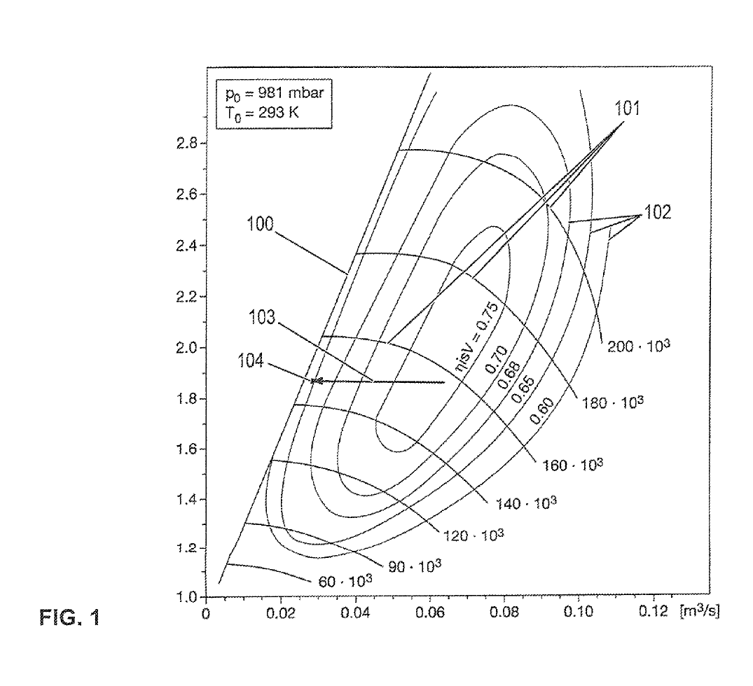

FIG. 1 shows an exemplary characteristic map of a compressor,

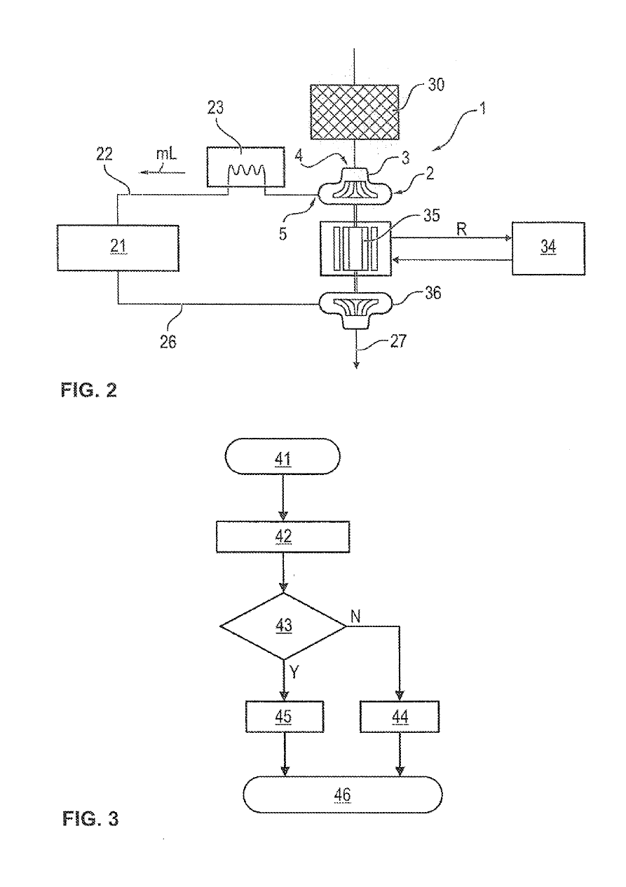

FIG. 2 shows an exemplary installation situation of a compressor with electric drive in the area of a combustion engine,

FIG. 3 schematically shows a flow diagram which can be implemented in terms of programming technology in a regulation device in order to control a compressor that is driven by electric motor,

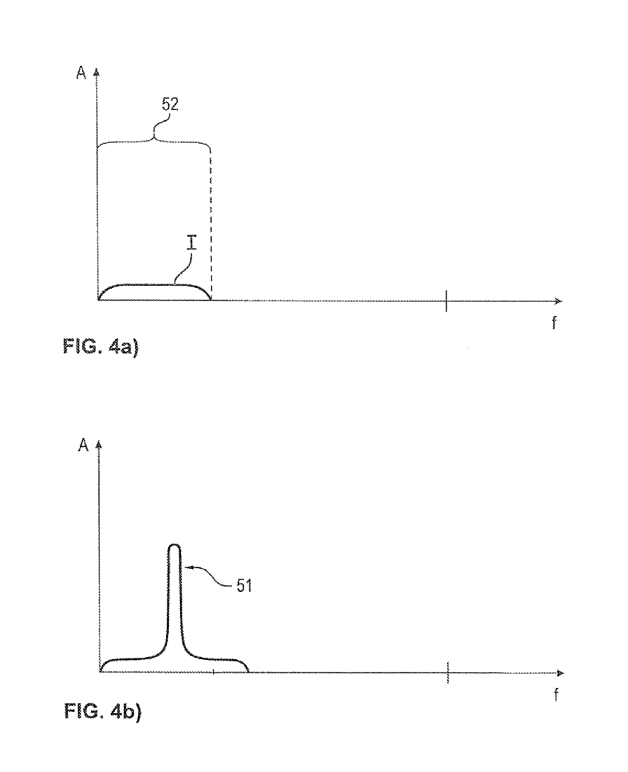

FIG. 4a) shows, by way of example, a diagram depicting amplitudes of regulation activity or intensity versus the frequency directly before the surge limit is reached, and

FIG. 4b) shows, by way of example, the diagram in the case of the surge limit being reached.

FIG. 1 shows, by way of example, a characteristic map of a compressor, based on an extract from a book by Michael Mayer and Günter Krämer: “Abgasturbolader” [“Exhaust-gas turbochargers”] Süddeutscher Verlag onpact GmbH, 81677 Munich, ISBN 978-3-86-236-026-0. The characteristic map is a diagram of a pressure ratio of a compressor 2 versus a volume flow rate. The surge limit 100 is illustrated in the characteristic map as a line. The admissible operating range of the compressor 2 is situated in the characteristic map to the right of the surge limit 100. Lines of equal rotational speed 101 are plotted in the characteristic map. These represent what pressure ratio is attained at a particular rotational speed of the compressor 2 in the case of a particular volume flow rate. For a constant volume flow rate, the pressure ratio increases with the rotational speed of the compressor 2. Also plotted in the characteristic map are lines of equal efficiency 102. For reasons relating to the operation of a downstream internal combustion engine or of a downstream fuel cell, it may be the case that the volume flow rate decreases toward the surge limit 100. In association with the deterioration of the efficiency, partial separation of the flow from the compressor wheel blades of the compressor 2 may occur. At the surge limit 100, said separation becomes so intense that the gas delivery action breaks down. If the compressor is equipped with a regulator which compensates the volume flow rate or the rotational speed or the pressure generation by the compressor, a regulation reaction can compensate deviations in the admissible range but in the vicinity of the surge limit. Directly before the surge limit is reached, there is an unstable region in which the onset of surging leads already to relatively intense regulation activity. However, when the surge limit 100 is reached, the surging becomes so intense that the regulation can no longer compensate the deviations. Abrupt changes in the flow conditions occur, which can lead to high forces being exerted on the rotor of the compressor 2. In this case, the axial bearing of the compressor 2 or of an electric motor 35 connected thereto can sustain damage. The surge limit 100 can however be identified on the basis of the regulation amplitudes. It is furthermore possible for the surge limit to be identified already before it is actually reached. In this case, increased regulation activity generally occurs owing to changing flow separation conditions. These can be identified before the surge limit 100 itself is reached. By way of example, an approach to the surge limit is indicated by the arrow 103. An operating state 104 is reached in which the regulation activity overshoots a threshold value of the surge limit or a threshold value. In particular in the case of the overshooting of the threshold value, countermeasures such as, for example, a regulation algorithm provided for this purpose can be initiated and thus damage to the compressor 2 or to the drive thereof can be prevented; this is also conceivable for the threshold value of the surge limit. The increased regulation activity can thus be utilized for the identification of the surge limit or of an approach thereto, and for the prevention of damage during the operation of the compressor 2. For this purpose, it is preferably the case that, if the surge limit 100 or an approach thereto is identified owing to more intense regulator activity, the operating point is moved further away from the unstable region and from the surge limit 100 in the direction of the admissible region.

FIG. 2 is a schematically simplified illustration of a combustion engine 21, for example in the form of an internal combustion engine or of a fuel cell. The combustion engine 21 has an intake line 22 in which the compressor 2 of the supercharging device 1 is arranged, said compressor being driven by an electric motor 35. A charge-air cooler 23 may be arranged downstream of the compressor 2 in the intake line 22. The air mass flow mL, symbolized by an arrow, from the compressor 2 is fed to a combustion engine 21, which may be an internal combustion engine or a fuel cell.

As is also shown in FIG. 2, the supercharging device 1 is provided with a regulation device 34 for motor control and for supplying electrical energy to the electric motor 35. Said regulation device 34 and power supply unit is symbolized in schematically simplified form in FIG. 2 by a block. Accordingly, the regulation device 34 is, depending on the embodiment, arranged at a suitable location outside or within the supercharging device 1. An exhaust-gas mass flow mA is conducted through a turbine 36 and subsequently fed to an exhaust-gas outlet 26. The turbine 36 may be connected in power-transmitting fashion to the compressor 2 in order to additionally drive the latter. Accordingly, to avoid the surge limit, it is also possible for the electric motor 35 to be operated in a generator mode in order to prevent surging by generating a braking action.

The compressor 2 is connected to the electric motor 35, by means of which the compressor 2 can be driven. The regulation device 34 for motor control and energy supply comprises a regulator (not illustrated) which regulates, and supplies electrical power to, the electric motor 35. In this case, regulation activity can be detected by the regulation device 34 for example on the basis of numerous deviations between a setpoint value and an actual value, in particular in the presence of different frequencies in accordance with FIGS. 4a) and 4b). In one refinement, the fact that an approaching surge limit has been reached can also be inferred by way of acoustically perceptible amplitudes of body-borne and airborne sound at different frequencies.

In a manner which is not illustrated, the regulation device 34 may have a microprocessor and a memory unit and may be designed to regulate the power electronics. The microprocessor may be designed to read and process programs stored on the memory unit for the purpose of regulating the power electronics and executing the method described herein.

FIG. 3 shows a simple flow diagram which may be implemented in the regulation device 34 for the purpose of regulating the electric motor 35. A start 41 is followed by a step 42 which involves a query regarding the intensity of regulation activity and/or the value of an integral of amplitudes over a frequency range. In a comparison 43, it is queried whether a product of the regulation activity with a regulation frequency is greater than a threshold value. The threshold value may be variable, and may be fixed for a discrete time period only when the surge limit is actually reached for the first time. If the response to the query 43 is “yes”, as indicated by the arrow labeled “Y”, the power output at the electric motor 35 is reduced in a step 45, for example by means of a reduction of the rotational speed. It is self-evidently also possible for some other measure, for example an increase of the air mass flow mL, to be implemented in order to depart from the region close to the surge limit. If the response to the query 43 is “no”, as symbolized by the arrow labeled “N”, the power output at the electric motor 35 is not changed from a present basic setting. In a step 46, the method is ended, whereupon it can return again to the start 41. The method may be executed continuously in the regulation device 34 in order to control the electric motor 35 and be able to operate as close as possible to the surge limit when required.

FIG. 4a) shows, by way of example, amplitudes A of regulation activity, plotted versus the frequency f, immediately before the surge limit is reached. An increase in the amplitudes can be seen in the low-frequency range. FIG. 4b) shows the amplitudes versus the frequency in the event of overshooting of the surge limit. At a particular frequency, there is a spike 51 in the amplitude, which is also acoustically perceptible as a characteristic tone. By determining an integral I, regulation activity in the frequency range can be detected. In this case, the threshold value may also be adapted during operation such that the state illustrated in FIG. 4b) is not encountered.

### LIST OF REFERENCE SIGNS

1 Supercharging device
2 Compressor
3 Compressor housing
4 Compressor housing inlet
5 Compressor housing outlet
21 Combustion engine
22 Intake line
23 Charge-air cooler
26 Exhaust line
27 Exhaust-gas outlet
29 Exhaust-gas cooler
30 Air filter
34 Regulation device
35 Electric motor
36 Turbine
41 Start
42 Detection of regulation activity
43 Comparison
44 Step
45 Step
46 End
51 Spike
52 Frequency range
100 Surge limit
101 Lines of equal rotational speed
102 Lines of equal efficiency
103 Approach of the operating state to the surge limit
104 Operating point close to the surge limit
A Amplitude
f Frequency
mL Air mass flow

1. A method for identifying a surge limit of a compressor (2), comprising
driving the compressor at least by an electric motor (35), the power of which is regulated by means of a regulation device (34),
detecting regulation activity with the regulation device (34) during the operation of the compressor (2), and
identifying a surge limit of the compressor (2) if the regulation activity overshoots a threshold value.

2. A method for operating a compressor (2) so as to prevent a surge limit, wherein the compressor is driven at least by an electric motor (35), the power of which is regulated by means of a regulation device (34), the method comprising
identifying a surge limit of the compressor (2) when the regulation activity overshoots a threshold value, and
in reaction to an overshooting of the threshold value, moving the operating state of the compressor (2) away from the surge limit.

3. The method as claimed in claim 1, wherein the threshold value is determined continuously in an adaptive manner during operation.

4. The method as claimed in claim 1, in which the threshold value is determined with a margin to a surge limit.

5. The method as claimed in claim 2, comprising operating the compressor (2) operates in an operating state close to the surge limit, and wherein the surge limit is not reached owing to the reaction to an overshooting of the threshold value.

6. The method as claimed in claim 1, in which the regulation activity is determined on the basis of a regulation amplitude (A) and a regulation frequency (f).

7. The method as claimed in claim 1, in which the regulation activity is determined on the basis of a regulation amplitude (A) and a regulation frequency.

8. A regulation device (34) for a compressor (2), which regulation device is programmed for carrying out the method as claimed in claim 1.

9. The regulation device (34) as claimed in claim 8, which forms a part of an engine controller of an internal combustion engine (21) or a part of a controller of a fuel cell.

10. The regulation device (34) as claimed in claim 8, which regulation device is in the form of a mechanically separate and/or functionally autonomous control/regulation device for the compressor (2) or for an electrically assisted turbocharger which has the compressor (2).

11. The method as claimed in claim 1, in which the regulation activity is determined on the basis of a multiplication of the regulation amplitude (A) and the regulation frequency (f).

12. The method as claimed in claim 1, in which the regulation activity is determined by determination of an integral (I) of the amplitudes (A) over a defined frequency range (52).
